(19) United States
(12) Patent Application Publication
(10) Pub. No.: US 2025/0196683 A1
(43) Pub. Date: Jun. 19, 2025

(54) ELECTRIC VEHICLE PARKING SYSTEM AND PARKING METHOD

(71) Applicants: HYUNDAI MOTOR COMPANY, Seoul (KR); KIA CORPORATION, Seoul (KR)

(72) Inventor: Yong Joon Lee, Incheon (KR)

(73) Assignees: HYUNDAI MOTOR COMPANY, Seoul (KR); KIA CORPORATION, Seoul (KR)

(21) Appl. No.: 18/763,590

(22) Filed: Jul. 3, 2024

(30) Foreign Application Priority Data
Dec. 14, 2023 (KR) 10-2023-0181410

(51) Int. Cl. B60L 53/36; B60W 30/06

(52) U.S. Cl. CPC B60L 53/36; B60W 30/06

(57) ABSTRACT

An electric vehicle parking method includes generating sensing data by sensing surroundings of an electric vehicle. The method includes searching for vacant spaces using the sensing data. The method includes determining whether a vacant space of the vacant spaces is a parking space for electric vehicles, a parking space for conventional vehicles, or an unparkable space. The method includes selecting the determined parking space for the electric vehicles as a target parking space. The method includes detecting a position of an electric vehicle charging device corresponding to the target parking space. The method includes determining a parking direction and a parking trajectory of the electric vehicle for the target parking space so that a charging port of the electric vehicle is disposed closed to the position of the electric vehicle charging device. The method includes moving the electric vehicle to the target parking space along the parking trajectory.

### CROSS-REFERENCE TO RELATED APPLICATIONS

The present application claims priority to Korean Patent Application No. 10-2023-0181410, filed on Dec. 14, 2023 in the Korean Intellectual Property Office, the entire contents of which are incorporated herein by reference.

### TECHNICAL FIELD

The present disclosure relates to an electric vehicle parking system and a parking method.

### BACKGROUND

The content described below simply provides background information related to the present embodiment and does not constitute the prior art.

Recently, the global market share of electric vehicles is increasing rapidly. As the number of electric vehicles increases, there is a high demand for expansion of infrastructure for charging electric vehicles. Electric vehicle chargers are mainly installed in public places, such as parking lots, airports, and rest areas.

Depending on the specifications of the electric vehicle, the electric vehicle charging port may be located at the front bumper, rear bumper, front left (left-side of the front fender), front right (right-side of the front fender), rear left (left-side of the rear fender), and rear right (right-side of the rear fender). To charge an electric vehicle, the parking direction and parking trajectory of the electric vehicle should be determined considering the location of the charging port.

Electric vehicle charging devices placed in parking lots may also be placed in various locations within the parking lot. For example, an electric vehicle charging device may be placed on one side of the parking space, such as the front, rear, left, and right sides of the parking space. In addition, electric vehicle charging devices may also be installed on the poles located on the sides of parking spaces.

Since the placement of electric vehicle charging devices may differ across parking lots, parking an electric vehicle to align the charging port to be adjacent to the electric vehicle charging device makes a parking task inconvenient for the electric vehicle user and reduces the user experience of the electric vehicle.

To increase the convenience of electric vehicle charging and parking, a method for automatically parking an electric vehicle is required. The method performs a parking process of the electric vehicle by automatically determining the parking direction and parking trajectory, detecting an electric vehicle charging device, and aligning the charging port of the electric vehicle to be adjacent to the electric vehicle charging device when the parking process is completed.

### SUMMARY

To solve the technical problems noted above, one object of the present disclosure is to provide a method for automatically performing a parking process of an electric vehicle.

Also, one object of the present disclosure is to provide a method for automatically detecting a parking space for electric vehicles and locations of electric vehicle charging devices.

Also, one object of the present disclosure is to provide a method for determining a charging direction and a charging trajectory for automatic charging of an electric vehicle.

Also, the present disclosure intends to solve a technical problem different from the conventional automatic parking process by considering the characteristics inherent to charging of an electric vehicle. For example, although the conventional automatic parking process has to only determine the trajectory for parking a vehicle within a parking space, an automatic parking method for charging an electric vehicle according to the present disclosure has to perform the parking process by considering the location of the electric vehicle charging device and the location of the charging port of the electric vehicle.

Technical objects to be achieved by the present disclosure are not limited to those described above, and other technical objects not mentioned above may also be clearly understood from the descriptions given below by those having ordinary skill in the art to which the present disclosure belongs.

### Advantageous Effects

As described above, according to the present disclosure, an automatic parking function may be performed for an electric vehicle and makes the parking process convenient.

Also, the present disclosure enables automatic detection of a parking space for electric vehicles and the location of electric vehicle charging devices.

Also, the present disclosure may automatically determine the parking direction and parking trajectory for automatic charging of an electric vehicle.

Also, the present disclosure may provide a versatile automatic charging method for an electric vehicle capable of performing cooperative control with existing or future automatic charging devices for electric vehicles. Here, automatic charging device may refer to a device for automatically charging an electric vehicle by automatically recognizing the charging port of the electric vehicle.

### BRIEF DESCRIPTION OF THE DRAWINGS

FIG. 1 is a functional block diagram of an electric vehicle parking system according to one embodiment of the present disclosure.

FIG. 2 illustrates a method for determining a parking space for electric vehicles according to one embodiment of the present disclosure.

FIGS. 3A, 3B, and 3C illustrate parking trajectory and parking direction for an electric vehicle according to one embodiment of the present disclosure.

FIGS. 4 and 5 illustrate a user interface according to one embodiment of the present disclosure.

FIG. 6 is a flow diagram of an electric vehicle parking system according to one embodiment of the present disclosure.

FIG. 7 is a flow diagram illustrating the S660 step of FIG. 6.

### DETAILED DESCRIPTION

Hereinafter, embodiments of the present disclosure are described in detail with reference to the accompanying drawings. In the following description, like reference numerals designate like elements, although the elements are shown in different drawings. Further, in the following description of embodiments, a detailed description of known functions and configurations incorporated therein has been omitted for the purpose of clarity and for brevity.

Additionally, various terms such as first, second, A, B, (a), (b), etc., are used solely to differentiate one component from the other but not to imply or suggest the substances, order, or sequence of the components. Throughout the present disclosure, when a part ‘includes’ or ‘comprises’ a component, the part is intended to further include other components and not intended to exclude other components unless specifically stated to the contrary. The terms such as ‘unit’, ‘module’, and the like refer to one or more units for processing at least one function or operation, which may be implemented by hardware, software, or a combination thereof.

Each element of the apparatus or method in accordance with the present disclosure may be implemented in hardware, software, or a combination of hardware and software. The functions of the respective elements may be implemented in software, and a microprocessor may be implemented to execute the software functions corresponding to the respective elements. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

The electric vehicle parking system 100 may perform the automatic parking function. Due to the automatic parking function, vehicle users may conveniently park their vehicle. The electric vehicle parking system 100 may automatically detect the parking space A1 for electric vehicles and locations of electric vehicle charging devices 200 and may determine a parking direction, a parking trajectory, or the like, i.e., hereinafter a parking trajectory 330 for charging an electric vehicle 270. The driver is not required to manually set the parking direction for charging the electric vehicle 270.

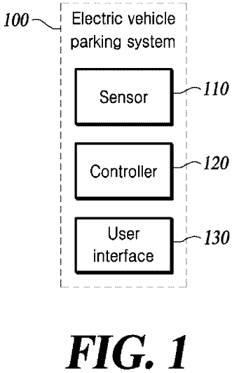

FIG. 1 is a functional block diagram of an electric vehicle parking system according to one embodiment of the present disclosure.

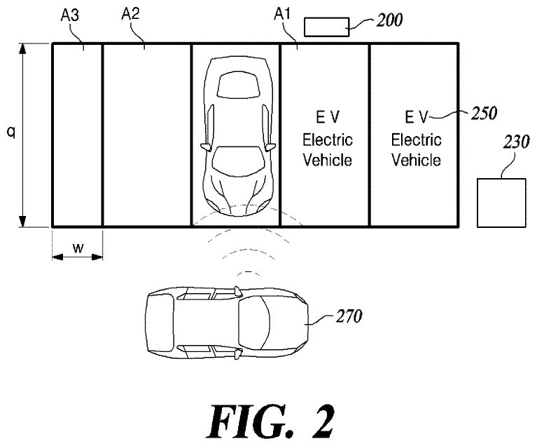

FIG. 2 illustrates a method for determining a parking space for electric vehicles according to one embodiment of the present disclosure.

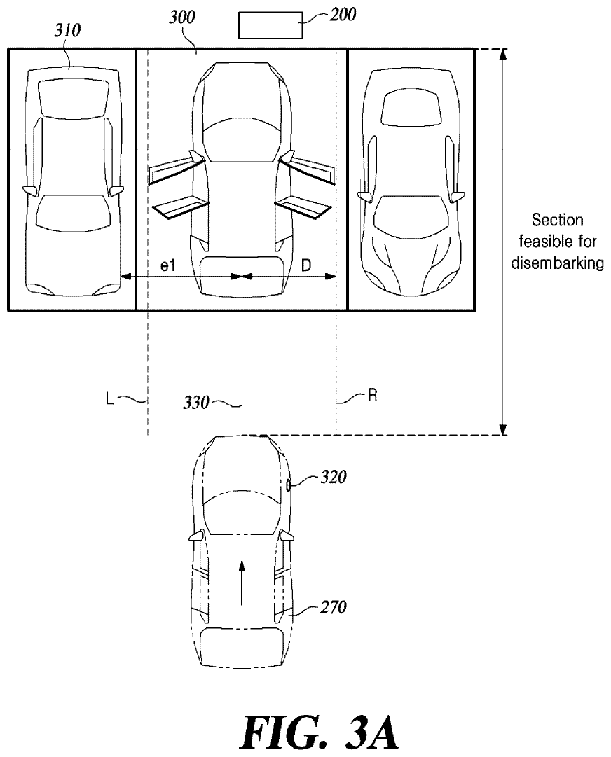

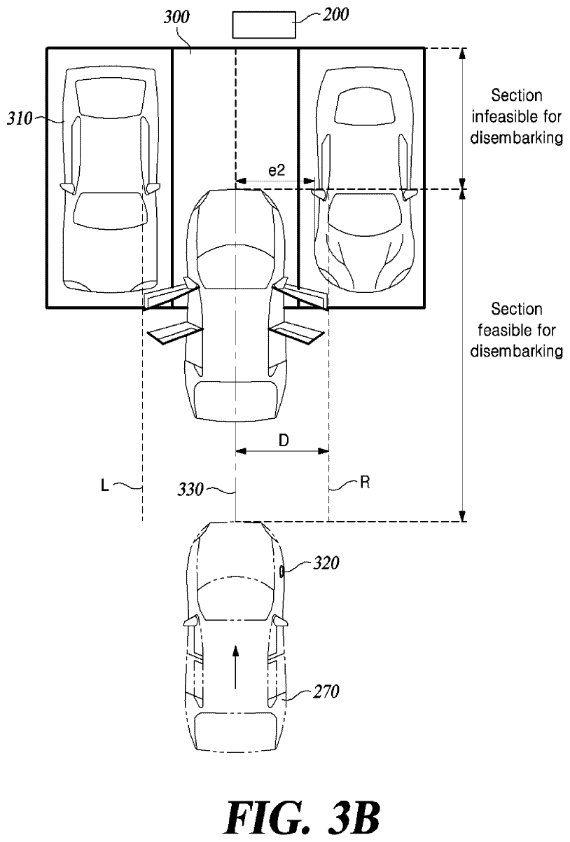

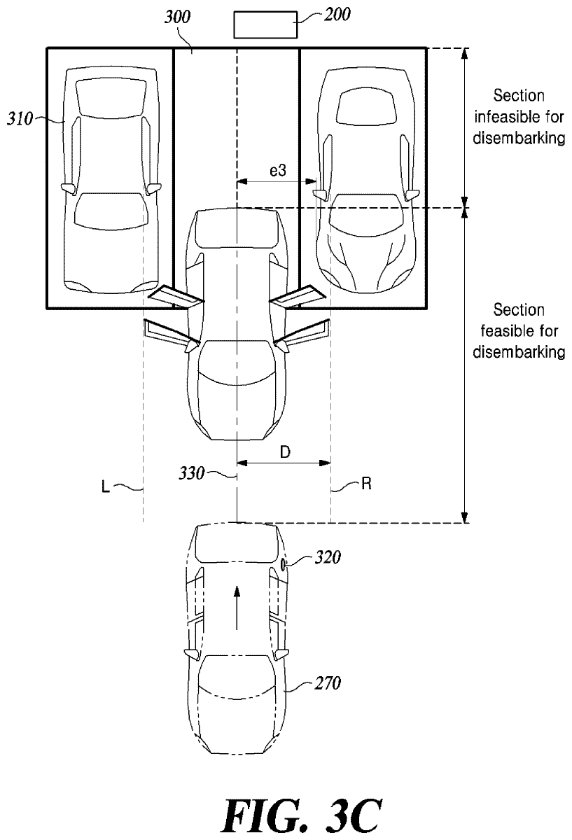

FIGS. 3A, 3B, and 3C illustrate parking trajectory and parking direction for an electric vehicle according to one embodiment of the present disclosure.

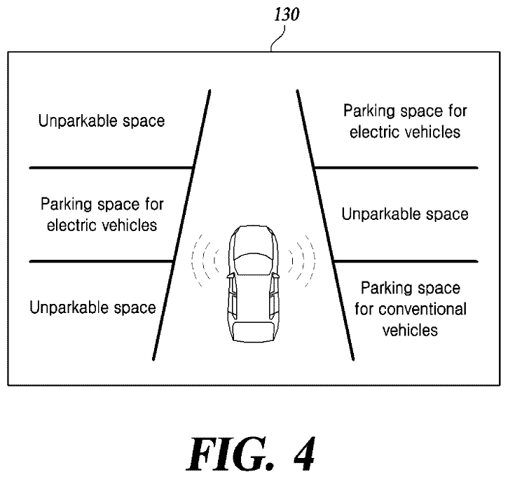

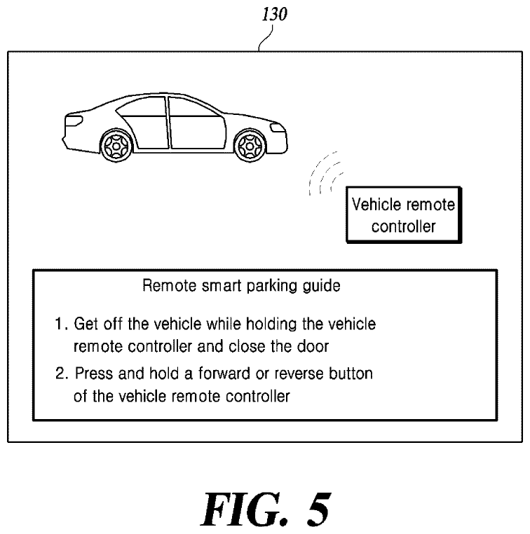

FIGS. 4 and 5 illustrate a user interface according to one embodiment of the present disclosure.

Referring to FIGS. 1-5, the electric vehicle parking system 100 includes all or part of a sensor 110, a controller 120, and a user interface 130.

The sensor 110 may sense the surroundings of the electric vehicle 270 and may generate sensing data. The sensor 110 may detect disembarking of a passenger and subsequent closing of the door. The sensor 110 may include all or some of a camera, a Light Detection And Ranging (LIDAR), or a Radio Detection And Ranging (RADAR). A plurality of cameras may be disposed in the electric vehicle 270. Each constituting element of the sensor 110 may be disposed in the front, rear, front side, or rear side of the vehicle.

The controller 120 may search for vacant spaces around the electric vehicle 270 using sensing data. The controller 120 may determine a space without an obstacle and/or an object that interferes with parking as a vacant space.

The controller 120 may determine whether each of the vacant spaces is a parking space A1 for electric vehicles, a parking space A2 for conventional vehicles, or an unparkable space A3. The controller 120 may determine whether a vacant space is an unparkable space A3 based on the width w and length q of the vacant space. For example, among vacant spaces, a space where its width w is narrower than a threshold width or its length q is shorter than a threshold length may be determined as an unparkable space A3.

The controller 120 may determine a place, among the vacant spaces, where an electric vehicle symbol 250 has been detected as a parking space A1 for electric vehicles. The controller 120 may recognize the electric vehicle symbol 250. The controller 120 may use an artificial intelligence (AI) engine trained to recognize the electric vehicle symbol 250. The controller 120 may select one of the spaces determined to be a parking space A1 for electric vehicles and the spaces determined to be a parking space A2 for conventional vehicles as a target parking space 300.

When the target parking space 300 is a parking space A1 for electric vehicles, the controller 120 may detect the location of the electric vehicle charger 200 corresponding to the target parking space 300. The controller 120 may detect the location of the electric vehicle charging device 200 using sensing data. The controller 120 may use an AI engine trained to recognize the electric vehicle charging device 200 for detecting the location of the electric vehicle charging device 200.

The controller 120 may determine the parking direction and parking trajectory 330 of the electric vehicle 270 for the target parking space 300 so that a charging port 320 of the electric vehicle may be aligned to be adjacent to the location of the electric vehicle charging device 200. The electric vehicle charging device 200 may be disposed to be adjacent to the parking space. For example, the electric vehicle charging device 200 may be disposed in one side of the parking space. The electric vehicle charging device 200 may be installed on a parking lot pillar 230. The electric vehicle charging device 200 may include a charging connector. The charging connector may be connected to the charging port 320 of the electric vehicle.

The controller 120 may determine the parking trajectory 330 so that the electric vehicle 270 may not collide with other vehicles, parking lot pillars 230, and objects or obstacles around the electric vehicle 270.

The controller 120 may detect a section where disembarking is feasible and a section where disembarking is infeasible from the parking trajectory 330. According to one embodiment, the controller 120 may detect a section in which disembarking is feasible based on a left line L and a right line R. The section where disembarking is feasible refers to a section without an obstacle and/or an object between the left line L and the right line R. If there are no obstacle and/or object within a first reference distance D from the parking trajectory 330, the controller 120 may determine the corresponding section as a section feasible for disembarking. If an obstacle and/or an object exists within the first reference distance D from the parking trajectory 330, the controller 120 may determine the corresponding section as a section infeasible for disembarking.

The controller 120 may move the electric vehicle 270 to the target parking space 300 along the parking trajectory 330. According to one embodiment, the controller 120 may stop the electric vehicle 270 moving to the target parking space 300 at a particular point in the section feasible for disembarking and may move the electric vehicle 270 again after all passengers of the electric vehicle 270 get off. According to one embodiment, the controller 120 may stop the electric vehicle 270 when a portion of the electric vehicle 270 enters the target parking space 300, and the controller 120 move the electric vehicle 270 again after all passengers of the electric vehicle 270 get off. According to one embodiment, the controller 120 may stop the electric vehicle 270 moving to the target parking space 300 at a particular point in the section feasible for disembarking and guide the passengers of the electric vehicle 270 to get off using the user interface 130 disposed inside the electric vehicle 270. To move the electric vehicle 270 to the target parking space 300 along the parking trajectory 330 in the case where a section infeasible for disembarking exists inside the target parking space 300, the controller 120 may stop the electric vehicle 270 right before the electric vehicle 270 enters the section infeasible for disembarking, and the controller 120 may move the electric vehicle 270 again after all passengers of the electric vehicle 270 get off. To move the electric vehicle 270 to the target parking space 300 along the parking trajectory 330 in the case where there is a passenger in the rear seat of the electric vehicle 270 and a section infeasible for disembarking exists inside the target parking space 300, during the reverse parking, the controller 120 may stop the electric vehicle 270 right before the C pillar of the electric vehicle 270 enters the target parking space 300 and may move the electric vehicle 270 again after all passengers of the electric vehicle 270 get off.

The user interface 130 may be disposed inside the electric vehicle 270. The user interface 130 may separately display a parking space A1 for electric vehicles, a parking space A2 for conventional vehicles, and an unparkable space A3. In this case, a passenger may select the target parking space 300 by touching the parking space for electric vehicles or the parking space for conventional vehicles displayed on the user interface 130.

The user interface 130 may guide passengers to get off the electric vehicle 270. For example, after the electric vehicle 270 is fully parked, a message instructing passengers to get off the vehicle may be displayed on the user interface 130.

The image and text of the parking space disclosed in FIG. 4 are not limited to the specific disclosure of the drawing. In other words, the configuration of the user interface 130 disclosed in FIG. 4, including the screen, images, and messages, is only an example, and changes may be made to the elements that are obvious to those having ordinary skill in the art.

The message of the user interface 130 shown in FIG. 5 is only an example introduced for the purpose of description. In other words, types of message produced by the user interface 130 are not limited to the example of the figure. It is also possible to output a message different from the message shown in FIG. 5. In addition, the user interface 130 may not only output a visual message but also may output a sound to guide passengers to get off the vehicle. The electric vehicle charging device 200 may be disposed on one side of the parking space. The location where the electric vehicle charging device 200 may be disposed is not limited to the example of the disclosed figure. In other words, the electric vehicle charging device 200 may be placed adjacent to the parking space A1, regardless of whether the electric vehicle charging device 200 is located at the front, rear, left-side, or right-side of the parking space A1. The electric vehicle charging device 200 may detect the position of the charging port 320 of the electric vehicle and may couple the charging connector to the charging port 320 of the electric vehicle.

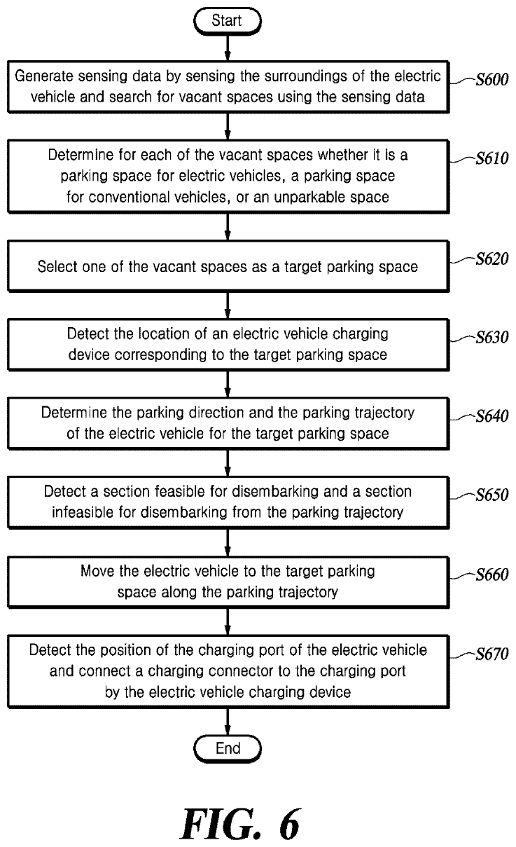

FIG. 6 is a flow diagram of an electric vehicle parking system according to one embodiment of the present disclosure.

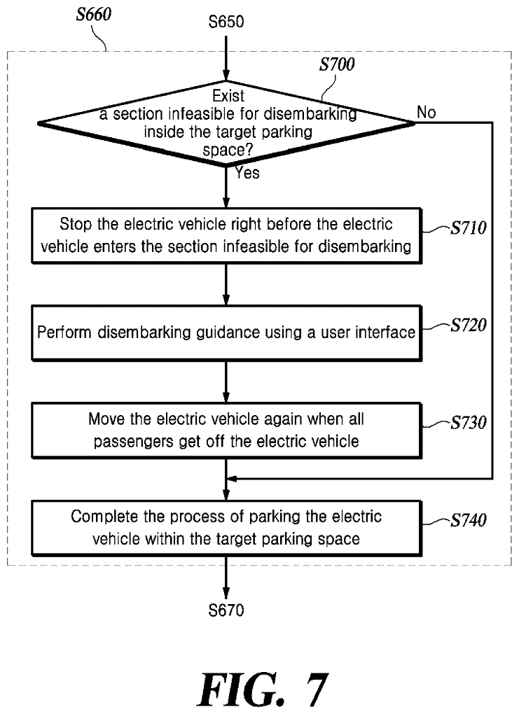

FIG. 7 is a flow diagram illustrating the S660 step of FIG. 6.

Referring to FIGS. 1-7, the electric vehicle parking system 100 may sense the surroundings of the electric vehicle 270, may generate sensing data, and may search for vacant spaces around the electric vehicle 270 using sensing data (S600). The electric vehicle parking system 100 may determine a space without an obstacle and/or an object that interferes with parking as a vacant space.

The electric vehicle parking system 100 may determine whether each of the vacant spaces is a parking space A1 for electric vehicles, a parking space A2 for conventional vehicles, or an unparkable space A3 (S610). The electric vehicle parking system 100 may determine whether a vacant space is an unparkable space A3 based on the width w and length q of the vacant space. For example, among vacant spaces, a space where its width w is narrower than a threshold width or its length q is shorter than a threshold length may be determined as an unparkable space A3.

If the width w of a vacant space is larger than or equal to the threshold width, and the length q is longer than or equal to the threshold length, the electric vehicle parking system 100 may determine the vacant space as a parking space.

The electric vehicle parking system 100 may recognize an electric vehicle symbol 250. The electric vehicle parking system 100 may determine a place, among the vacant spaces, where the electric vehicle symbol 250 has been detected as a parking space A1 for electric vehicles. The electric vehicle symbol 250 may be a symbol indicating that the corresponding space is the parking space A1 for electric vehicles. The electric vehicle symbol 250 may indicate that an electric vehicle may be charged in the corresponding space. To determine whether a space is the parking space A1 for electric vehicles, the electric vehicle parking system 100 may employ an AI engine trained to recognize the electric vehicle symbol 250. To distinguish the parking space A1 for electric vehicles from the parking space A2 for conventional vehicles, the electric vehicle symbol 250 may be displayed in various forms using shapes, letters, and other visual elements.

According to one embodiment, the electric vehicle symbol 250 may be placed on the ground of vacant spaces. According to one embodiment, the electric vehicle symbol 250 may be located on a parking lot pillar 230 disposed in one side of vacant spaces. According to one embodiment, the electric vehicle symbol 250 may be displayed on the electric vehicle charging device 200 disposed in one side of the vacant spaces.

The electric vehicle parking system 100 may select one of the spaces determined to be the parking space A1 for electric vehicles as the target parking space 300 (S620). The controller 120 may randomly select one of the vacant spaces and designate the selected space as the target parking space 300. According to one embodiment, the controller 120 may select, among vacant spaces, the space closest to the electric vehicle 270 as the target parking space 300.

According to one embodiment, the electric vehicle parking system 100 may display the parking space A1 for electric vehicles, the parking space A2 for conventional vehicles, and the unparkable space A3 on the user interface 130. According to one embodiment, the electric vehicle parking system 100 may select one of the spaces determined as the parking space A1 for electric vehicles and the spaces determined as the parking space A2 for conventional vehicles as the target parking space 300 based on a signal of the user interface 130 by a passenger.

Specifically, the user interface 130 may display the parking space A1 for electric vehicles, parking space A2 for conventional vehicles, and unparkable space A3, and the passenger may select one of the spaces as the target parking space 300. For example, the passenger may select the target parking space 300 by touching the parking space for electric vehicles or the parking space for conventional vehicles displayed on the user interface 130.

The electric vehicle parking system 100 may detect the location of the electric vehicle charging device 200 corresponding to the target parking space 300 (S630). The electric vehicle parking system 100 may detect the location of the electric vehicle charging device 200 using the sensing data obtained by the sensor 110. To detect the location of the electric vehicle charging device 200, the electric vehicle parking system 100 may use an AI engine trained to recognize the electric vehicle charging device 200.

The electric vehicle parking system 120 may determine the parking direction and parking trajectory 330 of the electric vehicle 270 for the target parking space 300 so that the charging port 320 of the electric vehicle may be aligned to be adjacent to the location of the electric vehicle charging device 200 (S640). For example, as shown in FIG. 3A, when the charging port 320 of the electric vehicle is located on the front right side of the electric vehicle 270, the electric vehicle parking system 100 may determine the parking trajectory 330 so that the charging port 320 of the electric vehicle is placed close to the electric vehicle charging device 200. In this case, the parking direction is determined to be the forward parking direction. This is because the charging port 320 of the electric vehicle and the electric vehicle charging device 200 are placed in opposite directions when the electric vehicle is positioned through reverse parking, and charging the electric vehicle is made impossible. Parking direction indicates either a forward parking direction or a reverse parking direction. The forward parking direction is the movement direction of a vehicle for forward parking. Forward parking refers to the parking of a vehicle by entering the parking space with the front portion of the vehicle first. Reverse parking refers to the parking of a vehicle by entering the parking space with the rear portion of the vehicle first. For example, FIGS. 3A and 3B correspond to forward parking, and FIG. 3C corresponds to reverse parking.

The electric vehicle parking system 100 may determine the parking trajectory 330 so that the electric vehicle 270 may not collide with other vehicles, parking lot pillars, and objects or obstacles around the electric vehicle 270.

The parking trajectory 330 refers to a movement path of the electric vehicle 270 during the parking process. The left line L and the right line R are virtual lines representing the movement path of the end point of the door of the electric vehicle 270 when the door is fully opened.

The left line L is positioned to the left of the parking trajectory 330 by a first reference distance D. The right line R is positioned to the right of the parking trajectory 330 by the first reference distance D. Here, the first reference distance D may be the distance from the parking trajectory 330 to the end point of the door of the electric vehicle 270 when the door is fully opened.

The electric vehicle parking system 100 may detect a section where disembarking is feasible and a section where disembarking is infeasible from the parking trajectory 330 (S650). The parking trajectory 330 may include a section feasible for disembarking and a section infeasible for disembarking. The section where disembarking is feasible refers to a section in which there are/is no obstacle and/or object in the surroundings of the electric vehicle 270, and a passenger may get off the electric vehicle 270. The section where disembarking is infeasible refers to a section in which there exists an obstacle and/or an object in the surroundings of the electric vehicle 270, and a passenger may not get off the electric vehicle 270 or may have difficulty in doing so.

According to one embodiment, the electric vehicle parking system 100 may detect a section in which disembarking is feasible based on the left line L and the right line R. The section where disembarking is feasible refers to a section without an obstacle and/or an object between the left line L and the right line R. If there are/is no obstacle and/or object within a first reference distance D from the parking trajectory 330, the electric vehicle parking system 100 may determine the corresponding section as a section feasible for disembarking. If an obstacle and/or an object exist/exists within the first reference distance D from the parking trajectory 330, the electric vehicle parking system 100 may determine the corresponding section as a section infeasible for disembarking.

For example, as shown in FIG. 3A, when there are/is no obstacle and/or object between the left line L and the right line R along the entire parking trajectory 330, the entire parking trajectory 330 becomes the section feasible for disembarking. When the parking process is completed within the target parking space 300, since a distance e1 from the parking trajectory 330 to the other vehicle 310 is larger than the first reference distance D, a passenger may get off the electric vehicle 270 even after the parking process is finished entirely.

For example, as shown in FIG. 3B, the parking trajectory 330 includes a section feasible for disembarking and a section infeasible for disembarking. In the case of FIG. 3B, since a section infeasible for disembarking exists within the target parking space 300, when the electric vehicle 270 enters the target parking space 300 beyond a predetermined distance, a passenger may not get off the electric vehicle 270 or may have difficulty in doing so. Specifically, in the case of a section infeasible for disembarking, another vehicle 310, which acts as an obstacle, exists between the left line L and the right line R. In other words, in the case of a section infeasible for disembarking, since a distance e2 from the parking trajectory 330 to the other vehicle 310 is shorter than the first reference distance D, a passenger may not fully open the door. Therefore, the passenger may not get off the electric vehicle or may have difficulty in doing so.

The electric vehicle parking system 100 may move the electric vehicle 270 to the target parking space 300 along the parking trajectory 330 so that the electric vehicle 270 may be parked within the target parking space 300 (S660). The S660 step may include a process for stopping the electric vehicle 270 moving to the target parking space 300 at a particular point in the section feasible for disembarking and moving the electric vehicle 270 again after all passengers of the electric vehicle 270 get off. For example, the S660 step may include a process for stopping the electric vehicle 270 when a portion of the electric vehicle enters the target parking space 300 and moving the electric vehicle 270 again when all passengers of the electric vehicle 270 get off. When the electric vehicle 270 is stopped to allow passengers to get off during the S660 step, the electric vehicle parking system 100 may use the user interface 130 disposed inside the electric vehicle 270 to provide guidance for passengers of the electric vehicle 270 to get off.

When the electric vehicle 270 is entirely parked in the target parking space 300, the electric vehicle charging device 200 may detect the position of the charging port 320 of the electric vehicle and may connect the charging connector to the charging port 320 of the electric vehicle (S670). Alternatively, the electric vehicle charging device 200 may be configured so that a user may manually operate the electric vehicle charging device 200 to connect to the charging port 320 of the electric vehicle. In this case, the user of the electric vehicle 270 may directly connect the charging connector of the electric vehicle charging device 200 to the charging port 320 of the electric vehicle and then may perform a charging process.

The S660 step is described in more detail with reference to FIG. 7.

The electric vehicle parking system 100 may determine whether there exists a section infeasible for disembarking inside the target parking space 300 (S700). For example, in the case of FIG. 3A, although there does not exist a section infeasible for disembarking inside the target parking space 300, a section infeasible for disembarking exists inside the target parking space 300 in the cases of FIGS. 3B and 3C (e2<D, e3<D).

The electric vehicle parking system 100 performs the S700 step and, if it is determined that a section infeasible for disembarking does not exist inside the target parking space 300 (No in S700), completes the process of parking the electric vehicle 270 within the target parking space 300 (S740). In this case, after the electric vehicle 270 is fully parked within the target parking space 300, the electric vehicle parking system 100 may guide passengers of the electric vehicle 270 to get off the electric vehicle 270. For example, after the electric vehicle 270 is parked completely, a message guiding the disembarking process may be displayed on the user interface 130.

If it is determined by performing the S700 step that there is a section infeasible for disembarking inside the target parking space 300 (Yes in S700), the electric vehicle parking system 100 may stop the electric vehicle 270 right before the electric vehicle 270 enters the section infeasible for disembarking (S710). When the electric vehicle 270 enters the section infeasible for disembarking, the passengers may not get off or may have difficulty in getting off. Therefore, the electric vehicle 270 is moved just before the electric vehicle 270 enters the section infeasible for disembarking, and the electric vehicle 270 is stopped to allow passengers to get off. As described above, when the electric vehicle 270 moves just before entering the section infeasible for disembarking and then stops, it contributes to efficient management of vehicle traffic in the parking lot.

According to one embodiment, when forward parking is performed, a section feasible for disembarking may be determined based on the front seat door, as shown in FIG. 3B. In other words, the section feasible for disembarking is limited to the parking trajectory 330 along which the front seat door may fully opened.

According to one embodiment, when reverse parking is performed while a passenger is present in the rear seat, a section feasible for disembarking may be determined based on the rear seat door as shown in FIG. 3C. In other words, the section feasible for disembarking is limited to the parking trajectory 330 along which the rear seat door may be fully opened.

According to one embodiment, when reverse parking is performed while no passenger is present in the rear seat, a section feasible for disembarking may be determined based on the front seat door, differently from the case of FIG. 3C. In this case, a section feasible for disembarking may be determined up to the position where the front seat door is fully opened, and the length of the section feasible for disembarking will be longer than that calculated based on the rear seat door. In other words, the electric vehicle 270 stops after it enters the target parking space 300 a lot further.

According to another embodiment, instead of stopping the electric vehicle 270 right before the electric vehicle 270 enters the section infeasible for disembarking, the electric vehicle 270 may be stopped right before the C pillar of the electric vehicle 270 enters the target parking space 300. For example, when a passenger is present in the rear seat of the electric vehicle 270 during the reverse parking, the electric vehicle 270 may be stopped right before the C pillar enters the target parking space 300 so that the passenger may easily get off the electric vehicle 270.

After the electric vehicle 270 is stopped, the electric vehicle parking system 100 may perform a disembarkation guide using the user interface 130 (S720). For example, the user interface 130 may display a message guiding passengers to disembark (see FIG. 5). As shown in FIG. 5, the user interface 130 may provide a guidance message instructing a passenger to get off while holding a vehicle remote controller.

The electric vehicle parking system 100 moves the electric vehicle 270 again when all passengers get off (S730). The electric vehicle parking system 100 may move the electric vehicle 270 again when it is confirmed that the passengers have disembarked, and the doors have been closed. The sensor 110 may detect the disembarkation of passengers and the door closure. It is also possible for part of the S730 step to be performed using the vehicle remote controller. For example, part of the S730 step may also be performed using a smart key or a digital key corresponding to the vehicle remote controller. The smart and digital keys are only examples of tools for remotely controlling a vehicle, and it should be noted that the vehicle remote controller according to the present disclosure is not limited to the smart keys. For example, the passenger of the electric vehicle 270 may manually move the electric vehicle 270 again using the vehicle remote controller. For example, the passenger may get off while holding the smart key, may close the door of the electric vehicle 270, and may press the button on the smart key to move the electric vehicle 270.

The electric vehicle parking system 100 completes the process of parking the electric vehicle 270 within the target parking space 300 (S740).

According to one embodiment, when the parking space A2 for conventional vehicles is selected as the target parking space 300, the electric vehicle parking system 100 may generate a parking trajectory 330 for performing reverse parking. In this case, the electric vehicle parking system 100 may perform reverse parking and may park the electric vehicle 270 in the target parking space 300.

Alternatively, according to one embodiment, when the parking space A2 for conventional vehicles is selected as the target parking space 300, the electric vehicle parking system 100 may generate a parking trajectory for charging the electric vehicle 270 without generating a parking trajectory for performing reverse parking. For example, when the parking space A2 for conventional vehicles is selected as the target parking space, the controller 120 of the electric vehicle parking system 100 may detect the position of the electric vehicle charging device 200 installed on the parking lot pillar 230 if the parking lot pillar 230 installed with the electric vehicle charging device 200 exists in one side of the selected parking space A2 for conventional vehicles; may determine the parking direction and the parking trajectory of the electric vehicle 270 so that the charging port 320 of the electric vehicle is disposed close to the position of the electric vehicle charging device 200; and control the electric vehicle 270 to move to the target parking space along the parking trajectory.

In other words, even if the parking space A2 for conventional vehicles is selected as the target parking space, when a parking lot pillar 230 adjacent to the parking space A2 for conventional vehicles exists, and the electric vehicle charging device 200 is installed on the parking lot pillar 230, the controller 120 may perform automatic parking for charging of the electric vehicle 270.

Various implementations of systems and techniques described herein may be realized as digital electronic circuits, integrated circuits, field programmable gate arrays (FPGAs), application specific integrated circuits (ASICs), computer hardware, firmware, software, and/or combinations thereof. These various implementations may include one or more computer programs executable on a programmable system. The programmable system includes at least one programmable processor (which may be a special-purpose processor or a general-purpose processor) coupled to receive and transmit data and instructions from and to a storage system, at least one input device, and at least one output device. The computer programs (also known as programs, software, software applications or codes) contain commands for a programmable processor and are stored in a “computer-readable recording medium”.

The computer-readable recording medium includes all types of recording devices in which data readable by a computer system is stored. Such a computer-readable recording medium may be a non-volatile or non-transitory medium, such as ROM, CD-ROM, magnetic tape, floppy disk, memory card, hard disk, magneto-optical disk, or a storage device, and may further include a transitory medium such as a data transmission medium. In addition, the computer-readable recording medium may be distributed in a computer system connected via a network, so that computer-readable codes may be stored and executed in a distributed manner.

Various implementations of systems and techniques described herein may be embodied by a programmable computer. Here, the computer includes a programmable processor, a data storage system (including volatile memory, non-volatile memory, or other types of storage systems, or combinations thereof), and at least one communication interface. For example, the programmable computer may be one of a server, a network device, a set top box, an embedded device, a computer expansion module, a personal computer, a laptop, a personal data assistant (PDA), a cloud computing system, or a mobile device.

Although embodiments of the present disclosure have been described for illustrative purposes, those having ordinary skill in the art should appreciate that various modifications, additions, and substitutions are possible, without departing from the idea and scope of the present disclosure. Therefore, embodiments of the present disclosure have been described for the sake of brevity and clarity. The scope of the technical idea of the present embodiments is not limited by the illustrations. Accordingly, one of ordinary skill should understand that the scope of the present disclosure should not be limited by the above explicitly described embodiments but by the claims and equivalents thereof.

What is claimed is:

1. An electric vehicle parking method comprising:
generating sensing data by sensing surroundings of an electric vehicle;
searching for vacant spaces using the sensing data;
determining whether a vacant space of the vacant spaces is a parking space for electric vehicles, a parking space for conventional vehicles, or an unparkable space;
selecting the determined parking space for the electric vehicles as a target parking space;
detecting a position of an electric vehicle charging device corresponding to the target parking space;
determining a parking direction and a parking trajectory of the electric vehicle for the target parking space so that a charging port of the electric vehicle is disposed closed to the position of the electric vehicle charging device; and
moving the electric vehicle to the target parking space along the parking trajectory.

2. The method of claim 1, wherein determining whether the vacant space of the vacant spaces is the parking space for the electric vehicles, the parking space for the conventional vehicles, or the unparkable space includes determining the vacant space as the unparking space in response to a determination that a width of the vacant space is less than a threshold width, or a length of the vacant space is shorter than a threshold length.

3. The method of claim 1, wherein determining whether the vacant space of the vacant spaces is the parking space for the electric vehicles, the parking space for the conventional vehicles, or the unparkable space includes determining the vacant space as the parking space for electric vehicles in response to a determination that an electric vehicle symbol is recognized for the vacant space.

4. The method of claim 3, wherein the electric vehicle symbol is placed on the ground of the vacant spaces or parking lot pillars disposed in one side of the vacant spaces.

5. The method of claim 1, wherein the parking direction includes a forward parking direction or a reverse parking direction.

6. The method of claim 1, further comprising:
detecting a section feasible for disembarking and a section infeasible for disembarking from the parking trajectory before moving the electric vehicle to the target parking space along the parking trajectory.

7. The method of claim 6, wherein the section feasible for disembarking is a section in which no obstacle is present within a first reference distance from the parking trajectory among the sections of the parking trajectory, and
wherein the section infeasible for disembarking is a section in which an obstacle is present within the first reference distance from the parking trajectory among the sections of the parking trajectory.

8. The method of claim 6, wherein moving the electric vehicle to the target parking space along the parking trajectory includes:
stopping the electric vehicle moving to the target parking space at a particular point in the section feasible for disembarking; and
moving the electric vehicle again when all passengers of the electric vehicle get off.

9. The method of claim 6, wherein, when the section infeasible for disembarking is present inside the target parking space, moving the electric vehicle to the target parking space along the parking trajectory includes:
stopping the electric vehicle in response to a determination that a portion of the electric vehicle enters the target parking space; and
moving the electric vehicle again when all passengers of the electric vehicle get off.

10. The method of claim 6, wherein moving the electric vehicle to the target parking space along the parking trajectory includes guiding passengers of the electric vehicle to get off using a user interface disposed inside the electric vehicle after stopping the electric vehicle moving to the target parking space at a particular point in the section feasible for disembarking.

11. The method of claim 6, wherein, when the section infeasible for disembarking is present inside the target parking space, moving the electric vehicle to the target parking space along the parking trajectory includes:
stopping the electric vehicle before the electric vehicle enters the section infeasible for disembarking; and
moving the electric vehicle again when all passengers of the electric vehicle get off.

12. The method of claim 6, wherein, when a passenger is present in a rear seat of the electric vehicle, and the section infeasible for disembarking is present inside the target parking space, moving the electric vehicle to the target parking space along the parking trajectory includes:
stopping the electric vehicle right before a C pillar of the electric vehicle enters the target parking space during reverse parking; and
moving the electric vehicle again when all passengers of the electric vehicle get off.

13. The method of claim 1, further comprising:
detecting the position of a charging port of the electric vehicle by the electric vehicle charging device; and
connecting a charging connector to the charging port of the electric vehicle by the electric vehicle charging device.

14. An electric vehicle charging system comprising:
a sensor configured to sense surroundings of an electric vehicle and generating sensing data; and
a controller configured to
search for vacant spaces around the electric vehicle using the sensing data,
determine whether a vacant space of the vacant spaces is a parking space for electric vehicles, a parking space for conventional vehicles, or an unparkable space,
select one of the determined parking space for the electric vehicles and the determined parking space for the conventional vehicles as a target parking space,
detect a position of an electric vehicle charging device corresponding to the target parking space when the target parking space is the determined parking space for the electric vehicles,
determine a parking direction and a parking trajectory of the electric vehicle for the target parking space so that a charging port of the electric vehicle is disposed closed to the position of the electric vehicle charging device, and
move the electric vehicle to the target parking space along the parking trajectory.

15. The system of claim 14, further comprising:
a user interface configured to display the parking space for electric vehicles, the parking space for conventional vehicles, and the unparking space, separately.

16. The system of claim 15, wherein, based on a signal of the user interface, the controller is configured to select one of the determined parking space for the electric vehicles and the determined parking space for the conventional vehicles as the target parking space.

17. The system of claim 14, wherein, when the determined parking space for the conventional vehicles is selected as the target parking space, and a parking lot pillar installed with an electric vehicle charging device is present in one side of the selected parking space for the conventional vehicles, the controller is configured to:
detect the position of the electric vehicle charging device installed on the parking lot pillar;
determine the parking direction and the parking trajectory of the electric vehicle for the target parking space so that the charging port of the electric vehicle is disposed close to the position of the electric vehicle charging device; and
move the electric vehicle to the target parking space along the parking trajectory.
